(19) United States
(12) Patent Application Publication
(10) Pub. No.: US 2019/0007292 A1
(43) Pub. Date: Jan. 3, 2019

(54) APPARATUS AND METHOD FOR MONITORING NETWORK PERFORMANCE OF VIRTUALIZED RESOURCES

(71) Applicant: Cpacket Networks Inc., San Jose, CA (US)

(72) Inventors: Ron Nevo, Portland, OR (US); Hal Heisler, Portland, OR (US); Murali Vinnakota, Santa Clara, CA (US)

(73) Assignee: Cpacket Networks Inc., San Jose, CA (US)

(21) Appl. No.: 15/636,535

(22) Filed: Jun. 28, 2017

(51) Int. Cl. H04L 12/26

(52) U.S. Cl. CPC H04L 43/0876; G06F 9/45533

(57) ABSTRACT

A machine has a processor and a memory connected to the processor. The memory stores instructions executed by the processor to observe network packet exchanges between virtualized resources. Key performance indicators characterizing packet information and connection information are generated from the packet exchanges. The key performance indicators are routed to a network connected device.

### CROSS-REFERENCE TO RELATED APPLICATION

This application is related to concurrently filed and commonly owned U.S. Ser. No. ______, filed May ______, 2017.

### FIELD OF THE INVENTION

This invention relates generally to communications in computer networks. More particularly, this invention is directed toward monitoring network performance of virtualized resources.

### BACKGROUND OF THE INVENTION

Networks continue to grow in size and line speed. This results in challenging network administration tasks since the volume of information to be analyzed is overwhelming. Existing techniques for generating warnings regarding potentially hazardous network activity result in many false positives. This is very distracting to network administrators.

Thus, there is a need for improved network monitoring techniques, including the monitoring of virtualized resources within a network.

### SUMMARY OF THE INVENTION

A machine has a processor and a memory connected to the processor. The memory stores instructions executed by the processor to observe network packet exchanges between virtualized resources. Key performance indicators characterizing packet information and connection information are generated from the packet exchanges. The key performance indicators are routed to a network connected device.

### BRIEF DESCRIPTION OF THE FIGURES

The invention is more fully appreciated in connection with the following detailed description taken in conjunction with the accompanying drawings, in which:

FIG. 1 illustrates a network utilized in accordance with an embodiment of the invention.

FIG. 2 illustrates a system configured in accordance with an embodiment of the invention.

FIG. 3 illustrates a management station configured in accordance with an embodiment of the invention.

FIG. 4 illustrates a forensic network device utilized in accordance with an embodiment of the invention.

FIG. 5 illustrates a virtual machine based network monitoring device configured in accordance with an embodiment of the invention.

FIG. 6 illustrates a container based network monitoring device configured in accordance with an embodiment of the invention.

Like reference numerals refer to corresponding parts throughout the several views of the drawings.

### DETAILED DESCRIPTION OF THE INVENTION

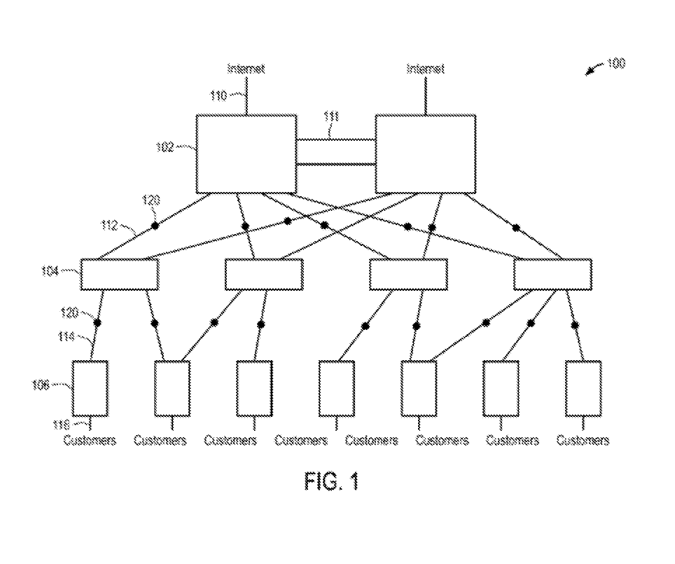

FIG. 1 illustrates an example of a network 100 with representative locations 120 at which a network device can be connected, in accordance with an embodiment of the invention. The network 100 is an example of a network that may be deployed in a data center to connect customers to the Internet. The connections shown in FIG. 1 are bidirectional unless otherwise stated. In one embodiment, the network 100 includes core switches 102, edge routers 104, and access switches 106. The core switches 102 provide connectivity to the Internet through multiple high-capacity links 110, such as 10-Gigabit Ethernet, 10 GEC 802.1Q, and/or OC-192 Packet over SONET links. The core switches 102 may be connected to each other through multiple high-capacity links 111, such as for supporting high availability. The core switches 102 may also be connected to the edge routers 104 through multiple links 112. The edge routers 104 may be connected to the access switches 106 through multiple links 114. The links 112 and the links 114 may be high-capacity links or may be lower-capacity links, such as 1 Gigabit Ethernet and/or OC-48 Packet over SONET links. Customers may be connected to the access switches 106 through physical and/or logical ports 116.

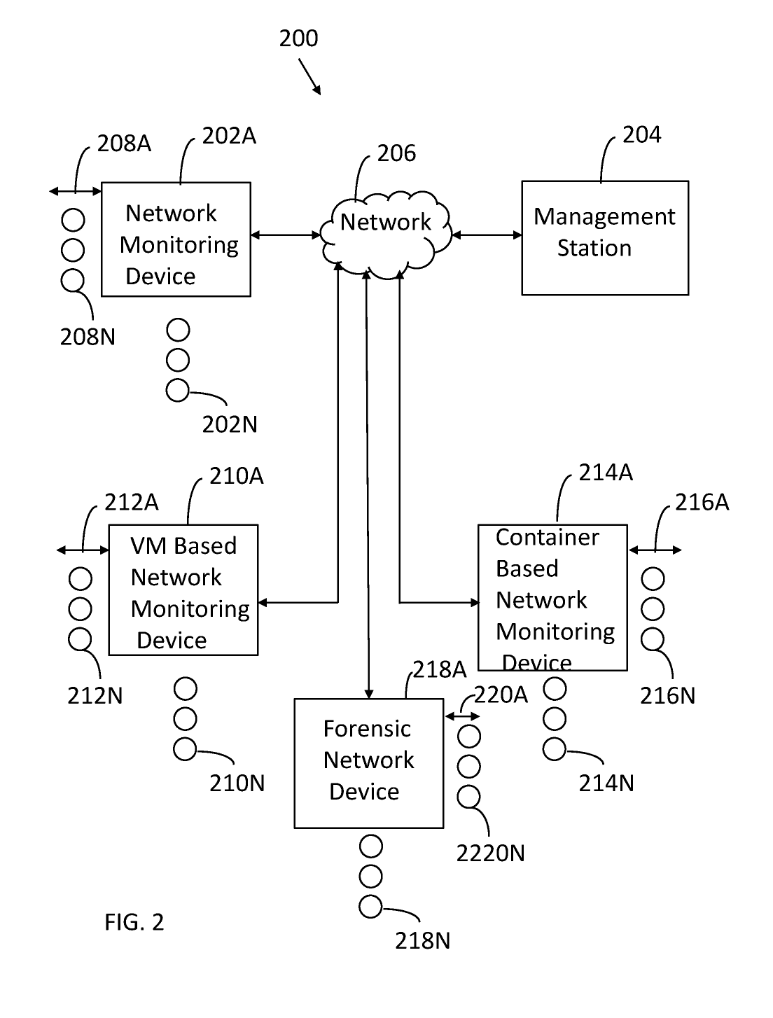

FIG. 2 illustrates a system 200 for network monitoring and network analysis, in accordance with an embodiment of the invention. The system 200 includes network monitoring devices 202A-202N that monitor and perform analyses, such as of network traffic. The network traffic that is monitored and analyzed by the network monitoring devices 202 may enter the network monitoring devices 202 through interfaces 208A-208N. After monitoring and analysis by the network monitoring devices 202, the network traffic may exit the devices through the interfaces if the interfaces are bidirectional, or through other interfaces (not shown) if the interfaces are unidirectional. Each of the devices 202 may have a large number of high-capacity interfaces 208, such as 32 10-Gigabit network interfaces.

In one embodiment, each of the network monitoring devices 202 may monitor and analyze traffic in a corresponding network 100, such as a data center network. Referring to FIG. 1, in one example the interfaces 208 may be connected to the network 100 at corresponding ones of the locations 120. Each of the interfaces 208 may monitor traffic from a link of the network 100. For example, in FIG. 1, one or more network monitoring devices 202 may monitor traffic on the links 112 and 114.

The network monitoring devices 202 are connected to a management station 204 across a network 206. The network 206 may be a wide area network, a local area network, or a combination of wide area and/or local area networks. For example, the network 206 may represent a network that spans a large geographic area. The management station 204 may monitor, collect, and display traffic analysis data from the network devices 202, and may provide control commands to the network devices 202. In this way, the management station may enable an operator, from a single location, to monitor and control network monitoring devices 202 deployed worldwide.

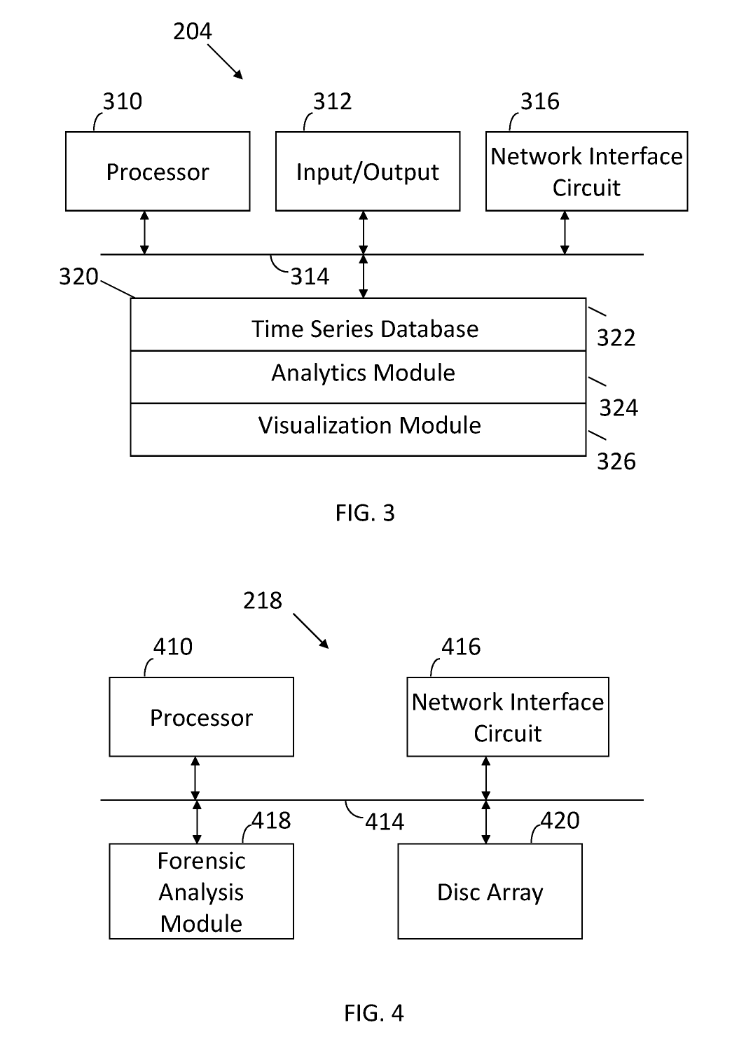

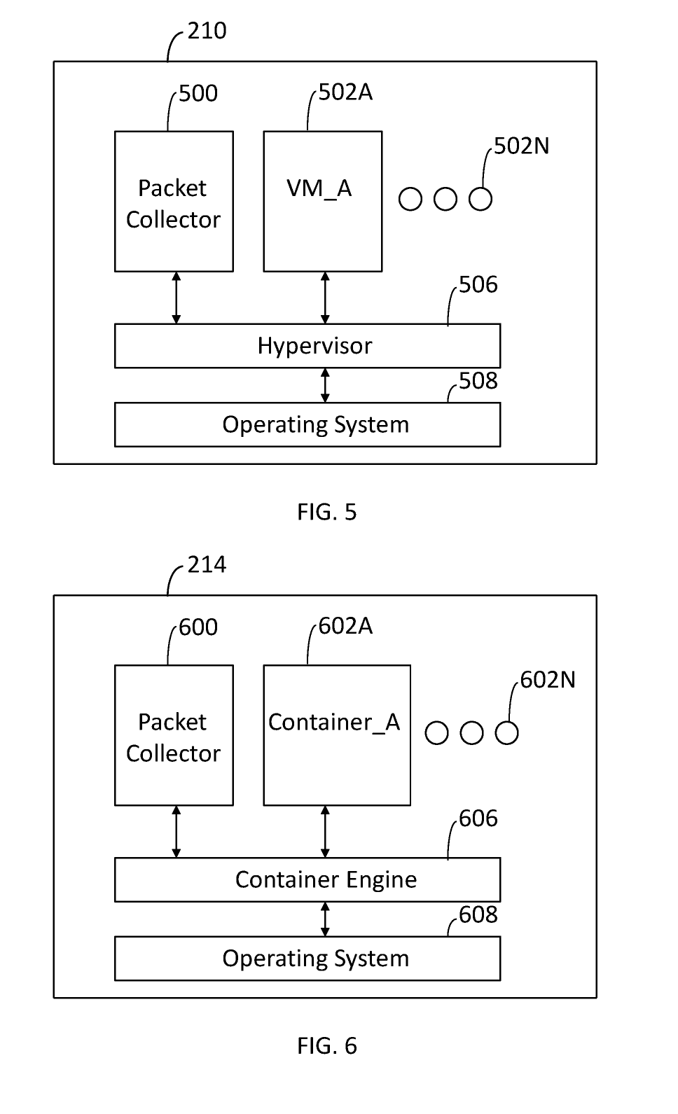

The components discussed up to this point are disclosed in U.S. Pat. No. 9,407,518, which is owned by the current applicant. U.S. Pat. No. 9,407,518 is incorporated herein by reference. The current application builds upon this architecture by utilizing a management station 204 with new features disclosed in connection with the discussion of FIG. 3. The system 200 also includes one or more virtual machine (VM) based network monitoring devices 210A-210N. Each VM based network monitoring device 210 includes interfaces, 212A-212N, which may be of the type discussed in connection with network device 202. The VM based network monitoring device 210 is more fully disclosed in connection with the discussion of FIG. 5.

In addition the system 200 includes one or more container based network monitoring devices 214A-214N. Each container based network monitoring device 214 includes interfaces 216A-216N, which may be of the type discussed in connection with network device 202. The container based network monitoring device 214 is more fully disclosed in connection with the discussion of FIG. 6.

The system 200 also includes one or more forensic network devices 218A-218N. Each forensic network device 218 includes interfaces 220A-220N, which may be of the type discussed in connection with network device 202. The forensic network device 218 is more fully characterized in connection with the discussion of FIG. 4.

FIG. 3 illustrates a management station 204 configured in accordance with an embodiment of the invention. The management station 204 may include standard components, such as a processor 310 connected to input/output devices 312 via a bus 314. The input/output devices 312 may include a keyboard, mouse, touch display and the like. A network interface circuit 316 is also connected to the bus. The network interface circuit 316 provides connectivity to network 206. A memory 320 is also connected to the bus 314. The memory 320 stores data and instructions executed by processor 310. In particular, the memory 320 stores a time series database 322, details of which are characterized below. The memory 320 also stores an analytics module 324. The analytics module 324 includes instructions executed by the processor 310 to provide network performance data as detailed below. A visualization module 326 is also stored in memory 320. The visualization module 326 includes instructions executed by the processor 310 to provide network performance visualizations representing the network performance data.

As discussed in previously incorporated U.S. Pat. No. 9,407,518, each network monitoring device 202 provides real-time high resolution (i.e., nanoseconds resolution) deep packet inspection data for every bit in every packet at line speed. Each device 202 generates packet level Key Performance Indicators (KPIs) which are continuously fed into the time series database 322. As discussed in more detail below, this facilitates distributed monitoring of a network.

FIG. 4 illustrates a forensic network device 218 utilized in accordance with an embodiment of the invention. The device 218 includes a processor connected to a network interface circuit 416 via a bus 414. The network interface circuit 416 provides connectivity to network 206. A disc array 420 is also connected to the bus 414. Random access memory 418 stores a forensic analysis module with instructions executed by processor 410. The disc array 420 stores packets at line rate. The forensic analysis module 418 includes instructions executed by the processor to perform port forwarding, aggregation, replication, balancing and filtering. The forensic analysis module 418 supports retrospective analysis of network operational issues and security incidents. In one embodiment, the forensic network device 218 generates session based KPIs. Sessions can be layer 4 Transmission Control Protocol (TCP) sessions or layer 7 sessions, such as Financial Information eXchange (FIX) transactions or Session Initiation Protocol (SIP) calls. The session level KPIs are fed to the time series database 322. The forensic network device 218 also captures packets that are forwarded to it and can be used to retrieve packet captures for deeper analyses.

FIG. 5 illustrates a VM based network monitoring device 210. The VM based network monitoring device 210 has functionality corresponding to the forensic network device 218, but is deployed on a virtual machine and monitors virtual host machines. Virtual host machine KPIs are forwarded to the time series database 322. In one embodiment, the VM based network device 210 includes a packet collector 500 in communication with a hypervisor 506. The hypervisor 506 operates in conjunction with the operating system 508 to host a set of virtual machines 502A-502N. VM based network monitoring device 210 also includes components of the type shown in FIG. 4, such as a processor 410, network interface circuit 416 and disc array 420. The packet collector 500 is analogous to the forensic analysis module 418.

FIG. 6 illustrates a container based network monitoring device 214. The container based network monitoring device 214 has functionality corresponding to the forensic network monitoring device 218, but is deployed in a container environment (e.g., Docker® sold by Docker, Inc., San Francisco, Calif.). Container KPIs are forwarded to the time series database 322. In one embodiment, the container based network monitoring device 214 includes a packet collector 600 in communication with a container engine 606. The container engine 606 operates in conjunction with the operating system 608 to host a set of containers 602A-602N. The operating system 608 works with the container engine 606 to designate for each container 602 its own filesystem, memory and devices. Container based network device 214 also includes components of the type shown in FIG. 4, such as a processor 410, network interface circuit 416 and disc array 420. The packet collector 600 is analogous to the forensic analysis module 418.

Packet collector 500 observes every packet exchange between virtual machines 502A-502N. Similarly, packet collector 600 observes every packet exchange between containers 602A-602N. Virtual machines 502A-502N and containers 602A-602N are virtualized resources. The term virtualized resources is used herein to cover both virtual machines and containers. Each packet collector processes all the packets it captures and creates relevant KPIs based on these packets. The KPIs capture significant network activity while effectively condensing the amount of information that must be forwarded to other network connected devices, such as the time series database 322 of the management station 204.

The KPIs may include packet information, such as Ethernet type, internet protocol type, packet length, high layer protocol information, such as Dynamic Host Configuration Protocol (DHCP) information, Hypertext Transfer Protocol (HTTP) information, HTTP Secure (HTTPS) information and the like. The KPIs may also include connection information. Each packet collector keeps track of connections for connection oriented protocols such as Transmission Control Protocol (TCP) and Session Initiation Protocol (SIP), which allows for the creation of KPIs such as session length, session time, session failure, such as retransmission timeouts and the like. Each packet collector maintains these KPIs internally and can report them to the time series database 322. In addition, each packet collector maintains local storage of the actual packets captured in a circular buffer such that one or more consumers can retrieve these packets when needed. This methodology allows for a very efficient usage of the management and monitoring of a network without overwhelming the network by sending all the packets for analysis by a single centralized server. In other words, the disclosed techniques provide a fully distributed scalable solution for monitoring of virtualized resources.

Attention now turns to the data collected by the time series database 322. The following terms are used to characterize this data.

| Terms | Description |
|---|---|
| database | A logical container for users, retention policies, continuous queries, and time |
| | series data. |
| field key | The key part of the key-value pair that makes up a field. Field keys are strings |
| | and they store metadata. |
| field set | The collection of field keys and field values on a point. |
| field value | The value part of the key-value pair that makes up a field. Field values are the |
| | actual data; they can be strings, floats, integers, or Booleans. A field value is |
| | associated with a timestamp. |
| | Field values are not indexed - queries on field values scan all points that match |
| | the specified time range and, as a result, are not performant. |
| measurement | The part of database structure that describes the data stored in the associated |
| | fields. Measurements are strings. |
| point | The part of database data structure that consists of a single collection of fields |
| | in a series. Each point is uniquely identified by its series and timestamp. |
| retention policy | The part of the database's data structure that describes for how long the |
| | database keeps data (duration), how many copies of those data are stored in |
| | the cluster (replication factor), and the time range covered by shard groups |
| | (shard group duration). |
| | Retention policies are unique per database and along with the measurement |
| | and tag set define a series. |
| series | The collection of data in the database's data structure that share a |
| | measurement, tag set, and retention policy. |
| tag key | The key part of the key-value pair that makes up a tag. Tag keys are strings |
| | and they store metadata. Tag keys are indexed so queries on tag keys are |
| | performant. |
| tag set | The collection of tag keys and tag values on a point. |
| tag value | The value part of the key-value pair that makes up a tag. Tag values are strings |
| | and they store metadata. Tag values are indexed so queries on tag values are |
| | performant. |
| timestamp | The date and time associated with a point. In one embodiment, time in the |
| | database is UTC. |

Data may be loaded into the time series database 322 using a variety of techniques. For example, a command line and an application interface may be used. Below is an example insert command:
curl-I-XPOST ‘http://localhost:8086/write?db=indicators’ persecond, p_nm=Port01

Below are exemplary keywords and values that may be used in accordance with embodiments of the invention.

| keywords | Example |
|---|---|
| database | Indicators |
| measurement | Persecond, per subsecond |
| tag set | p_nm=Port01,d_ip=10.51.10.109,m_type=port,d_id=2,device=c400_109,d |
| tag key | p_nm |
| tag value | Port01 |
| field set | hrcrx_avg_byt=923298.0,hrcrx_min_pkt=14204.0,hrcrx_std_byt=31.9572 |
| field key | hrcrx_avg_byt |
| field value | 923298.0 |

Below are exemplary queries that may be expressed against the time series database 322.
“show series”—Lists all the series available in the database
“SHOW TAG KEYS FROM′persecond”′—Shows all the tag keys that exist in the persecond measurement
“show tag values with key=‘port’”—Shows all the tag values for the tag key ‘port’
“SELECT mean(“gt_cnt_byt”)/10 FROM “persecond” WHERE “device”˜/̂c400_109 $/AND “port”˜/̂17$/AND “cb_g”˜/̂(group-0|group-1)$/AND time>now( )-5m GROUP BY time(100 ms), “cb_g” fill(null)”—Query gt_cnt_byt from persecond
“select port,device, hrc_max_pkt, hrc_max_byt, hrc_avg_pkt, hrc_avg_byt, f_name FROM “persecond” where f_name=˜/̂Rule.*/limit 10”—Select specified counters for all the filter name starting with Rule

Tag values may be expressed on per-second or sub-second levels. Each time frame has an associated indicator. Below is a list of tag values that may be associated with indicators.

| Tag | NamePossible Values | Comment |
|---|---|---|
| device | | Name of the device |
| d_ip | | IP address of the device |
| d_id | 1 - 65536 | this is the 2 byte device id that |
| | | every cvu will have |
| dp_type | counter, cburst, | Data point type: Will represent the |
| | hrckpi | category of that particular |
| | | point. |
| m_type | filter, port, cb_grp | Measurement Type: Will represent |
| | | lowest granular entity that is |
| | | being captured in that particular |
| | | point |
| port | 1 - 128 | The possible ports |
| p_nm | | Port names |
| pg | | Port group name |
| cb_g | all, none, group-1 | cBurst group classification |
| | ... group-256 | |
| f_id | | Filter ids |
| f_name | | Filter names. |

Below is a description of data points that may be collected in connection with indicators.

| dp_type | m_type | Description |
|---|---|---|
| Counter | port | per second counter values that are read from |
| | | regular counters at port level |
| Hrckpi | port | per second counter values that are read from |
| | | hrckpi counters at port level |
| Hrckpi | filter | per second counter values that are read from |
| | | hrckpi counters at filter level |
| Cburst | cb_grp | per second counter values that are read from |
| | | cburst counters at group level |

Below are examples of fields for different data points.

| | |
|---|---|
| (dp_type, | Fields |
| m_type) | |
| (counter, | rx_crc,_rx_frame_error, _drop_byt, _drop_pkt, _arp_byt, |
| port) | _arp_pkt, _icmp_byt, _icmp_pkt, _ipv4_byt, _ipv4_pkt, |
| | _ipv6_byt, _ipv6_pkt, |
| | _tcp_byt, _tcp_pkt, _tcp_syn_byt, _tcp_syn_pkt, |
| | _tcp_synack_byt, _tcp_synack_pkt, _tcp_fin_byt, |
| | _tcp_fin_pkt, _tcp_rst_byt, _tcp_rst_pkt, |
| | _udp_byt, _udp_pkt, _other_byt, _other_pkt, |
| | _not_ipv4_ipv6_byt, _not_ipv4_ipv6_pkt, |
| | _framesize00_byt, _framesize00_pkt, _framesize01_byt, |
| | _framesize01_pkt, _framesize02_byt, _framesize02_pkt, |
| | _framesize03_byt, _framesize03_pkt, _framesize04_byt, |
| | _framesize04_pkt, _framesize05_byt, _framesize05_pkt, |
| | _framesize06_byt, _framesize06_pkt, _framesize07_byt, |
| | _framesize07_pkt, |
| | _qos00_byt, _qos00_pkt, ... , qos63_byt, _qos63_pkt |
| (hrckpi, | hrctx_avg_pkt, hrctx_max_pkt, hrctx_min_pkt, hrctx_std_pkt, |
| port) | hrctx_max_byt, hrctx_std_byt, hrctx_avg_byt, hrctx_min_byt |
| | hrcrx_avg_pkt, hrcrx_max_pkt, hrcrx_min_pkt, hrcrx_std_pkt, |
| | hrcrx_max_byt, hrcrx_std_byt, hrcrx_avg_byt, hrcrx_min_byt, |
| (hrckpi, | hrc_max_pkt, hrc_max_byt, hrc_min_pkt, hrc_min_byt, hrc_avg_pkt, |
| filter) | hrc_avg_byt, hrcstd_pkt ,hrc_std_byt |

The analytics module 324 processes data in the time series database 322. In one embodiment, the analytics module 324 defines baseline network behavior and produces analytics and alerts based upon the baseline network behavior. The analytics may be displayed by the visualization module 326 (e.g., the visualization module 326 renders a visualization, which is displayed on a monitor connected to the input/output ports 312).

Many network administrators report being overwhelmed by data. They do not need more raw data. They need a more intelligent summary of the large volume of data that represents network activity.

As previously discussed, the network device 202 captures network traffic at line rate on each monitored link and generates performance analytics (and complete packet inspection) in real-time for network administrators. Therefore, the network device 202 captures a large amount of raw data. In addition, VM based network monitoring devices 210A-210N, container based network monitoring devices 214A-214N and forensic network devices 218A-218N may be generating data.

The data alone is not very useful to the network administrators that are already overwhelmed by data. Therefore, there is a need to distill this data into useful, actionable information.

Given the ability of a network monitoring device 202 to capture network traffic at line rate and generate analytics from this traffic, there is an opportunity to analyze and forecast the traffic in a network. This allows one to extract meaningful information from the line-rate data collected from the network monitoring devices 202A-202N and other devices of FIG. 2.

The analytics module 324 creates baselines from historical network traffic. These baselines can be used to determine when the network traffic is behaving as expected or exhibiting unusual characteristics. In the case of unusual characteristics, one can look for abnormal network behaviors that might indicate an attack or other potential issue.

Often network traffic exhibits a weekly pattern. Think of a business network. The network will experience reduced traffic over the weekends and during weekday nights when employees are at home. The network traffic will pick up each morning as employees arrive to work and decrease as employees go home for the day. Therefore, the traditional time series approach of correlating the future traffic with the previous short time period (seconds to hours) completely ignores the fundamental forces driving the network traffic.

Most authors use time series analysis to model and predict network traffic. This correlates the future traffic with the traffic of the recent past. In some cases, authors add a seasonal component to their traffic. Often this seasonal component is short (from minutes up to a day). Sometimes this seasonal component is annual.

The analytics module 324 utilizes a weekly pattern and assumes that it is going to be significant for a large percentage of the networks deploying network monitoring devices 202A-202N. Therefore, rather than looking at a sliding window of time (employing a single time series analysis of the network traffic), traffic is sliced into time segments per weekday. This leads to multiple time series, each with a weekly time step.

Prior art models network traffic with a single time series. Rather than create a time series out of the microsecond to second data, as is commonly found in the literature, an embodiment of the invention aggregates data into longer time samples (for example, between 10 and 20 minutes and, in one embodiment, 15 minute time intervals). These time samples are then treated as a time series with time steps of one week. This process creates multiple “parallel” time series.

For example, if one aggregates data into 15 minute samples, then one will have 96 time series per day (96=60*24/15), giving a total of 672 individual time series per week (672=7*96). Each time series incorporates data from the previous weeks. This historical data is used to predict the traffic for the same time slot in the next week. As data is captured for the current day, it is compared to the baseline (calculated the previous week) to determine what actions to take, if any.

There are many approaches to calculating the baseline for the time interval in the next week. The baseline can be calculated using a simple moving average, an exponential moving average, Holt-Winters exponential smoothing, or a trend plus an autoregressive process, an autoregressive-moving-average model or using a more complicated detrended time series model (ARIMA, GARCH, Neural Networks, etc.).

It is believed that there is a strong correlation between the network traffic for the previous weeks and the network traffic for the current week. Therefore, relatively simple models perform adequately (moving average, exponentially weighted moving average, Holt-Winters exponential smoothing or an autoregressive process plus trend).

All of these models (mentioned above) require an initial phase to get started. For the first couple of weeks of collecting data, one can initialize the baseline with a simple average. Once enough data has been collected, one can calculate the chosen model from the existing data. For a straight-forward autoregressive model, one needs to extract the trend, plus choose the model order and the number of weeks of data to use for fitting the autoregression model to the data.

The Holt-Winters model incorporates both a linear trend and a seasonal trend in the model (and many of the other models can also include seasonal components). Since the word “seasonal” does not explicitly appear above, one might ask why include the Holt-Winters exponential smoothing model as an option. The answer is that the weekly data will potentially show both a weekly trend and a yearly seasonal trend (“Black Friday,” for example). Hence, embodiments of the invention include a yearly seasonal trend in models. However, the impact of the yearly seasonal trend is not available for the baseline calculation until the start of the second year of data collection.

Note that the weekly time series models are not calculated once and then frozen for all future baseline calculations. Each week the time series models are updated based upon the network traffic received on the current day. The newly updated models are used to calculate the baseline for the following week. This means that the time series models used to calculate the baselines will most likely differ each week.

In one embodiment, each device 202A-202N stores aggregated per-second data in the time series database 322. Using the maximum value of the collected data tends to be uninteresting. The maximum moves up toward the line rate and then stays there. In addition, the average value is often too small to capture the bursts in the traffic. The average is usually orders of magnitude lower than the actual bursts on the link.

Using a percentile of the maximum values, such as 70 percentile of the maximum values, shows a behavior that appears to be more predictable than the maximum bit rate or average bit rate. Therefore, an embodiment of the baselining code uses the 70% quantiles of the maximum per-second data stored in the time series database 322. For instance, if the 70th percentile of the maximum per-second traffic for the current day exceeds the maximum of the 70th percentiles for the previous N weeks, then it is known that the network traffic for the current day is abnormal relative to the recent history. A similar statement can be made if the 70th percentile of the maximum per-second traffic for the current day drops below the minimum of the 70th percentiles for the previous N weeks.

Sometimes a non-recurring event might happen that significantly impacts the network traffic. In this case, it might be inappropriate to include the data collected during this event into the baseline calculation. For this reason, the analytics module 324 is configured to allow one to specify days (and time intervals within days) to be excluded from the baseline calculations.

In addition to calculating a baseline, it is desirable to provide the network administrator with an estimate for the quality of the baseline. There are a variety of approaches one could take to estimate the accuracy of the baseline. A simple estimate of the accuracy is to take a moving average (or weighted moving average) of the previous absolute prediction errors (absolute differences between the measured data and the corresponding baseline).

When using an autoregressive model to calculate the baseline, one can use the accompanying theory of linear predictors to estimate the prediction error of the baseline by calculating the mean squared prediction error for the autoregressive model. However, the standard calculation of the mean squared prediction error is an optimistic lower bound on the prediction error, not a good estimate of the prediction error. Since the variance of the process is an upper bound on the mean squared prediction error, one can approximate the quality of the baseline by estimating the variance of the weekly data values.

The analytics module 324 is configured to generate alerts in response to material deviations from baseline behavior. The expected baseline behavior is presented to the user as an envelope around the baseline function. The envelope comprises a function above the baseline and a function below the baseline that estimate the range that is expected to predominantly represent the future network traffic. Reference to network behavior baseline contemplates the actual network behavior baseline or the network behavior baseline and the envelope. The analytics module 324 is configurable to define a deviation threshold, such as a 10% deviation threshold from the network behavior baseline, a 15% deviation threshold from the network behavior baseline, or a 20% deviation threshold from the network behavior baseline. The analytics module may, at the user's option, choose to compare the raw network traffic or a smoothed version of the network traffic to the network behavior baseline. The user may also choose a minimum amount of time the traffic needs to exceed the deviation threshold from the network behavior baseline in order to trigger an alert. The analytics module 324 is also configurable to define material deviations in the context of known events that may impact the baseline behavior. For example, an expected blockbuster media release may be used to specify greater thresholds for what are considered deviations from baseline behavior.

The analytics module 324 is configured to generate an alert in response to current network behavior that exceeds a deviation threshold. The alert may be a signal applied to network 206, such as an email or text, which is directed toward one or more designated individuals, such as network administrators. The analytics module 324 is also configurable to adjust the severity of the alert as a function of the severity of the deviation from baseline behavior.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A machine, comprising:
a processor; and
a memory connected to the processor, the memory storing instructions executed by the processor to:
observe network packet exchanges between virtualized resources,
generate from the packet exchanges key performance indicators characterizing packet information and connection information, and
route the key performance indicators to a network connected device.

2. The machine of claim 1 wherein the packet information is selected from Ethernet type, internet protocol type, packet length and a high layer protocol.

3. The machine of claim 1 wherein the connection information is selected from Transmission Control Protocol (TCP) information and Session Initiation Protocol (SIP) information.

4. The machine of claim 1 wherein the connection information is selected from session length, session time, session failure information and retransmission timeout information.

5. The machine of claim 1 wherein the virtualized resources are virtual machines.

6. The machine of claim 1 wherein the virtualized resources are containers.

7. The machine of claim 1 in combination with the network connected device comprising a device processor and a device memory connected to the device processor, the device memory storing instructions executed by the device processor to maintain a time series database storing the key performance indicators, the time series database including individual time series wherein each individual time series includes tag keys, tag values and a common data retention policy.

8. The network connected device of claim 7 wherein the tag keys are strings that store metadata.

9. The network connected device of claim 8 wherein the metadata is selected from device name, device address, data point type, measurement type, port name and filter name.
